(19) United States
(12) Patent Application Publication
(10) Pub. No.: US 2026/0209084 A1
(43) Pub. Date: Jul. 23, 2026

(54) HYDRODYNAMIC SEPARATOR WITH ALTERNATING BAFFLES

(71) Applicant: Advanced Drainage Systems, Inc., Hilliard, OH (US)

(72) Inventors: Bo LIU, Clarksburg, MD (US); Erik HARTWELL, Mount Airy, MD (US); Robin MALISZEWSKYJ, Middletown, MD (US); Gordon BAUGH, Columbus, OH (US); Jordan TENANDAR, Columbus, OH (US)

(73) Assignee: Advanced Drainage Systems, Inc., Hilliard, OH (US)

(21) Appl. No.: 19/397,587

(22) Filed: Nov. 21, 2025

Related U.S. Application Data
(60) Provisional application No. 63/748,105, filed on Jan. 22, 2025.

(51) Int. Cl. C02F 1/38; C02F 103/00

(52) U.S. Cl. CPC C02F 1/38; C02F 2103/001; C02F 2201/002

(57) ABSTRACT

The disclosed embodiments include a separator configured to remove particulate matter and pollutants from a flow of stormwater. The separator may comprise a tubular body comprising an inlet chamber and a sump chamber separated by an upper cone, a vertical cylinder extending from the inlet chamber to the sump chamber, a plurality of upward baffles in the sump chamber, wherein the plurality of upward baffles may extend towards an inner wall of the tubular body, a plurality of downward baffles in the sump chamber, wherein the plurality of downward baffles may be attached to the vertical cylinder, and wherein the plurality of upward baffles and the plurality of downward baffles may alternate along a length of the vertical cylinder.

### CROSS-REFERENCE TO RELATED APPLICATIONS

This application claims the benefit of priority of U.S. Provisional Application No. 63/748,105, filed Jan. 22, 2025, the contents of which are incorporated herein by reference in their entirety.

### TECHNICAL FIELD

This disclosure relates generally to systems, methods, and apparatuses for removing sediment and suspended solids from a flow of stormwater, and more particularly, to removing sediment and suspended solids from a flow of stormwater through use of a hydrodynamic separator.

### BACKGROUND

Stormwater management systems may be used to divert a flow of stormwater, such as runoff from rainfall events, from impervious surfaces and buildings. Stormwater management systems may, for example, include stormwater chambers or crates in which sediment, debris, pollutants, or particulates may be removed from stormwater. As such, stormwater chambers or crates may be provided underground to capture stormwater and to separate and retain particulates until they are deposited in the ground or in an off-site location.

Stormwater management systems may also use hydrodynamic separators to remove suspended solids, sediment, and other contaminants from stormwater. A hydrodynamic separator may be installed as part of a stormwater management system to remove particulates from the flow of stormwater before the stormwater enters a stormwater management chamber or crate. Improvements to hydrodynamic separators are needed to increase the amount of particulate matter that may be separated from the flow of stormwater. Such improved hydrodynamic separators may neutralize velocities of the flow of stormwater to allow more particulate matter to separate from the flow of the stormwater within a sump chamber of the hydrodynamic separator. Such improved hydrodynamic separators may also mitigate the risk of resuspended sediment short circuiting to the outlet of the separator under high flow conditions.

### SUMMARY

The disclosed embodiments describe systems, methods, and devices for a separator configured to remove particulate matter and pollutants from a flow of stormwater. The separator may comprise a tubular body, the tubular body comprising an inlet chamber and a sump chamber separated by an upper cone, a vertical cylinder extending from the inlet chamber to the sump chamber, a plurality of upward baffles in the sump chamber, wherein the plurality of upward baffles may extend towards an inner wall of the tubular body, a plurality of downward baffles in the sump chamber, wherein the plurality of downward baffles may extend to and/or be attached to the vertical cylinder, and wherein the plurality of upward baffles and the plurality of downward baffles may alternate along a length of the vertical cylinder.

In some embodiments, the tubular body may further comprise an inlet and an outlet. In some embodiments, the inlet chamber may be configured to contain the flow of stormwater entering the tubular body from the inlet. In some embodiments, a diameter of the upper cone may correspond to a diameter of the tubular body. In some embodiments, the upper cone may further comprise a bypass weir configured to prevent the flow of stormwater in the inlet chamber from exiting the inlet chamber through the outlet. In some embodiments, the vertical cylinder may comprise a plurality of connected vertical sections, wherein each of the plurality of vertical sections taper from a larger first end inwardly towards a smaller second end. In some embodiments, the vertical cylinder may comprise an inlet port configured to allow the flow of stormwater to enter the sump chamber from the inlet chamber. In some embodiments, the sump chamber may be configured to allow sediments to settle from the flow of stormwater at a base of the sump chamber.

In some embodiments, each of the plurality of upward baffles may comprise, a first end, comprising a first diameter, a second end, comprising a second diameter, and wherein the first diameter may be larger than the second diameter. In some embodiments, the second end of the plurality of upward baffles may be located below the first end. In some embodiments, the separator may further comprise a gap between the second end of each of the plurality of upward baffles and the vertical cylinder. In some embodiments, each of the plurality of downward baffles may comprise a first end, comprising a first diameter, a second end, comprising a second diameter, and wherein the first diameter may be larger than the second diameter. In some embodiments, the second end of the plurality of downward baffles may be located above the first end. In some embodiments, the separator may further comprise a gap between the first end of each of the plurality of downward baffles and an inner wall of the tubular body. In some embodiments, the plurality of upward baffles and the plurality of downward baffles may extend at an angle between 0 degrees to 65 degrees. In some embodiments, a space between an adjacent one of the plurality of upward baffles and one of the plurality of downward baffles may comprise a distance between about 2 inches to about 13 inches. In some embodiments, the plurality of upward baffles may comprise three upward baffles. In some embodiments, the plurality of downward baffles may comprise three downward baffles. In some embodiments, the flow of stormwater may be configured to flow between the plurality of upward baffles and the plurality of downward baffles to an outlet. In some embodiments, the plurality of upward baffles and the plurality of downward baffles may be configured to reduce a velocity of the flow of stormwater.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure, and together with the description, serve to explain the principles of the disclosed embodiments.

FIG. 1A depicts a separator with a plurality of alternating baffles, according to disclosed embodiments.

FIG. 1B depicts an enlarged section cut of a vertical cylinder with a plurality of alternating baffles, according to disclosed embodiments.

FIG. 1C depicts an enlarged section cut of a vertical cylinder with a plurality of alternating baffles, according to disclosed embodiments.

FIG. 1D depicts an enlarged view of a vertical cylinder with an upper cone and a plurality of alternating baffles, according to disclosed embodiments.

FIG. 1E depicts an enlarged top view of an upward baffle, according to disclosed embodiments.

FIG. 1F depicts an enlarged view of an upward baffle, according to disclosed embodiments.

FIG. 2A depicts a side view of a separator with a plurality of alternating baffles, according to disclosed embodiments.

FIG. 2B depicts a rear view of a separator with a plurality of alternating baffles, according to disclosed embodiments.

FIG. 3 depicts a section cut of a separator with a plurality of alternating baffles, according to disclosed embodiments.

FIGS. 4A-4D depict an enlarged section cut of a separator with a plurality of parallel baffles, according to disclosed embodiments.

FIGS. 5A-5D depict an enlarged section cut of a separator with a plurality of parallel baffles of varying widths, according to disclosed embodiments.

FIGS. 6A-6D depict an enlarged section cut of a separator with a plurality of non-parallel baffles, according to disclosed embodiments.

FIGS. 7A-7D depict an enlarged section cut of a separator with a plurality of non-parallel baffles of varying widths, according to disclosed embodiments.

FIG. 8A depicts a separator with plate extensions around the plurality of alternating baffles, according to disclosed embodiments.

FIG. 8B depicts a plate extension, according to disclosed embodiments.

FIG. 8C depicts an enlarged view of a plate extension connection to a baffle, according to disclosed embodiments.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing hydrodynamic separators by providing a separator with an upper cone and a plurality of alternating baffles located in the sump chamber of the separator. The plurality of alternating baffles of the disclosed embodiments may increase the surface area of the baffles within the sump chamber of the separator which may improve settling of particulate matter from the flow of stormwater. Additionally, the disclosed embodiments may neutralize the velocity of the flow of stormwater entering the sump chamber of the separator which may improve the settling of particulate matter from the flow of stormwater. The disclosed embodiments may further mitigate the risk of resuspended sediment short circuiting to the outlet under high flow conditions.

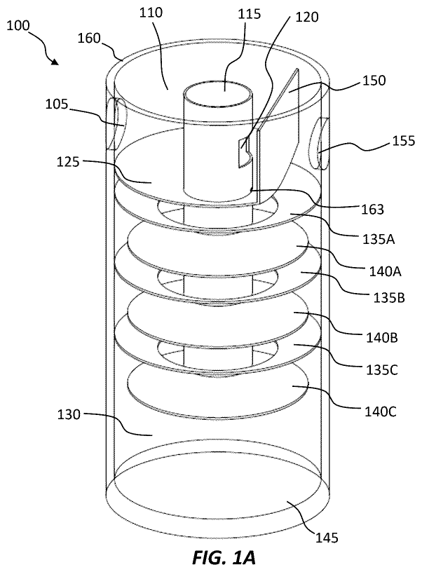

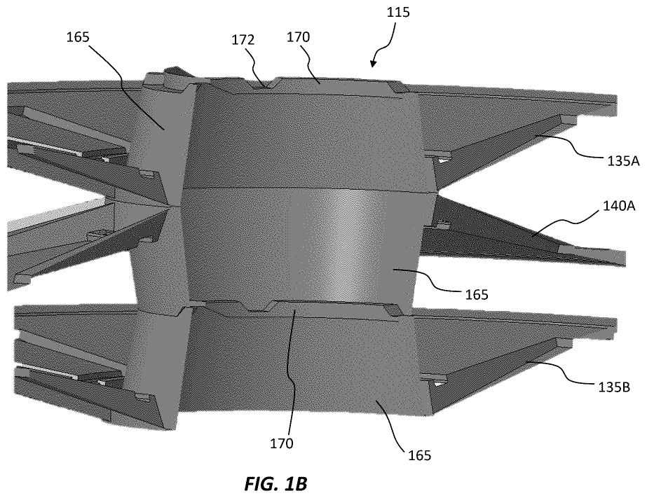

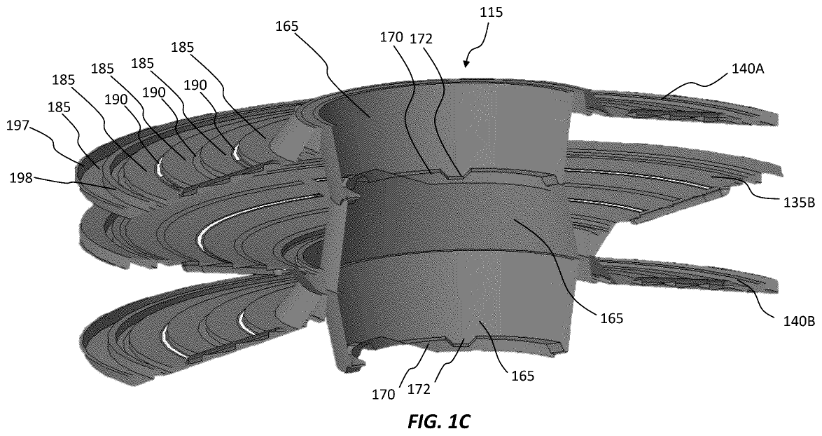

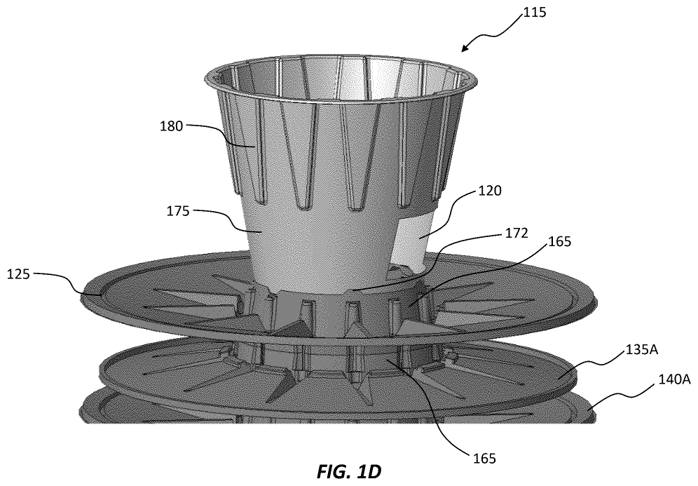

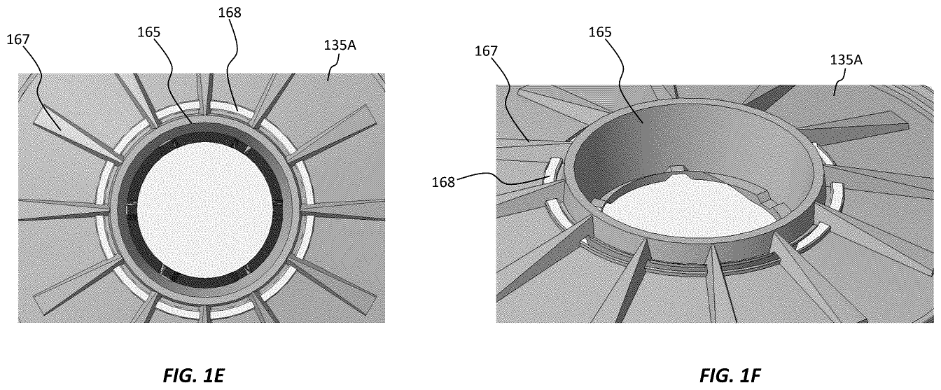

FIG. 1A depicts separator 100, in accordance with disclosed embodiments. Separator 100 may include tubular body 160, which may enclose a flow of stormwater within separator 100. In some embodiments, a diameter of tubular body 160 may range from about 3 feet to about 12 feet. In other embodiments, the diameter of tubular body 160 may be less than about 3 feet or greater than about 12 feet. In some embodiments, a height of tubular body 160 may be greater than about 4 feet. In other embodiments, the height of tubular body 160 may be about 4 feet or less. Tubular body 160 may extend upwardly from base 145 and may comprise inlet 105 and outlet 155.

Inlet 105 may comprise an opening in a wall of tubular body 160, which may allow a flow of stormwater to enter separator 100. In some embodiments, as depicted in FIG. 1A, tubular body 160 may comprise one inlet 105. In other embodiments (not shown), tubular body 160 may comprise a plurality of inlets 105 which may be spaced apart from one another around the circumference of tubular body 160. The plurality of inlets 105 may be spaced equidistantly apart in some embodiments. In other embodiments, the distances between adjacent inlets 105 may vary. In such an embodiment, the plurality of inlets may be at a similar height on tubular body 160 or may be at varying heights on tubular body 160. Outlet 155 may comprise an opening in the wall of tubular body 160 that may allow a flow of treated stormwater to exit separator 100. In some embodiments, an inflow pipe may be installed through inlet 105 to direct a flow of stormwater into separator 100 from a source. In some embodiments, an outflow pipe may be installed through outlet 155 to direct a flow of treated stormwater from within separator 100 to other components in a stormwater management system. In some embodiments, inlet 105 and outlet 155 may include features that may extend from an outward surface of tubular body 160. In such embodiments (not shown), an inflow pipe and/or an outflow pipe may be connected to separator 100 by surrounding or attaching to the features extending from the outward surface of tubular body 160.

Separator 100 may further include inlet chamber 110 and sump chamber 130 separated by upper cone 125. Inlet chamber 110 may contain a flow of stormwater that enters separator 100 through inlet 105. Sump chamber 130 may receive the flow of stormwater from inlet chamber 110 and allow sediment and particulates to settle out of the flow of stormwater at base 145 of sump chamber 130, as disclosed herein.

Upper cone 125 may separate inlet chamber 110 from sump chamber 130. Upper cone 125 may comprise a cone-shape with a first end and a second end. In some embodiments, the first end and the second end of upper cone 125 may be circular in shape. The first end may comprise a larger diameter than the second end of upper cone 125. Upper cone 125 may be oriented in tubular body 160 such that the larger first end is located above the smaller second end. The larger first end of upper cone 125 may contact the inner walls of tubular body 160 to create a barrier between inlet chamber 110 and sump chamber 130. A diameter of the larger first end of upper cone 125 may correspond to the diameter of tubular body 160. In some embodiments, the diameter of the larger first end of upper cone 125 may be greater than or less than a diameter of tubular body 160. For example, in some embodiments, a diameter of the larger first end of upper cone 125 may range from about 3 feet to about 12 feet. In other embodiments, the diameter of the larger first end of upper cone 125 may be less than about 3 feet or greater than about 12 feet. In some embodiments, upper cone 125 may be attached to the inner wall of tubular body 160. For example, upper cone 125 may be mounted to the inner wall of tubular body 160 using a mounting bracket or any other form of attachment.

Upper cone 125 may further comprise a bypass weir 150 located at the first end of upper cone 125. Bypass weir 150 may block outlet 155 to prevent a flow of stormwater in inlet chamber 110 from exiting separator 100 through outlet 155 up to a predetermined flow rate. If the flow of stormwater into inlet chamber 110 exceeds the predetermined flow rate, then bypass weir 150 may allow the flow of stormwater to bypass sump region 130 and exit inlet chamber 110 through outlet 155. For example, bypass weir 150 may extend upwardly from upper cone 125 and cover outlet 155 from inlet chamber 110. Bypass weir 150 may also provide an opening between upper cone 125 and the inner walls of tubular body 160 to allow the stormwater to exit sump chamber 130 through outlet 155.

Separator 100 may further include vertical cylinder 115. Vertical cylinder 115 may extend between inlet chamber 110 and sump chamber 130 and may facilitate the flow of stormwater from inlet chamber 110 to sump chamber 130. Vertical cylinder 115 may neutralize the velocity of the stormwater as it flows through vertical cylinder 115 to sump chamber 130 from inlet chamber 110. Vertical cylinder 115 may include an inlet port 120 and drain port 163. Inlet port 120 may comprise an opening in vertical cylinder 115 that may allow the flow of stormwater to enter vertical cylinder 115 from inlet chamber 110 and flow downwardly to sump chamber 130. Drain port 163 may comprise an opening in vertical cylinder 115 above upper cone 125 that may allow settled sediment to be washed to sump chamber 130 during cleanout. In some embodiments, drain port 163 may comprise a circular opening in vertical cylinder 115. For example, in some embodiments, drain port 163 may comprise a circular opening with a diameter of one inch. In other embodiments, a diameter of a circular drain port 163 may be greater than or less than one inch. In other embodiments, drain port 163 may be rectangular, square, elliptical, or any other shape opening. For example, during use of separator 100, sediment and particulates may settle out of the flow of stormwater to the base of upper cone 125 within inlet chamber 110. Drain port 163 may allow the settled sediment and particulates to be washed through vertical cylinder 115 into sump chamber 130 to facilitate cleanout of separator 100. Although FIG. 1A depicts one drain port 163, vertical cylinder 115 may include more than one drain port.

Upper cone 125 may be molded to vertical cylinder 115 at the smaller second end of upper cone 125. In some embodiments, vertical cylinder 115 may comprise a corrugated-walled tubular body. In other embodiments, vertical cylinder 115 may comprise a smooth-walled tubular body. In some embodiments, as depicted in FIG. 1A, vertical cylinder 115 may comprise a circular cylinder. In other embodiments, vertical cylinder 115 may comprise a polygonal cylinder. For example, vertical cylinder 115 may be pentagonal, hexagonal, octagonal, or any other polygonal shape.

In other embodiments, as depicted in FIG. 1B and FIG. 1C, vertical cylinder 115 may be formed from a plurality of connected vertical sections 165. For example, in some embodiments, each of upward baffles, such as upward baffles 135A and 135B, and downward baffles, such as downward baffle 140A, may be molded to a vertical section 165. Each vertical section 165 may include a larger end and a smaller end. In some embodiments, each of the larger end and the smaller end of vertical section 165 may be circular in shape. In other embodiments, each of the larger end and the smaller end of vertical section 165 may be rectangular, square, elliptical, polygonal, or any other shape. The walls of vertical section 165 may taper from the larger end inwardly towards the smaller end. Vertical sections 165 may be attached to form vertical cylinder 115, through which a flow of stormwater may flow, as disclosed herein. For example, vertical sections 165 may be attached by flanges 170. Flanges 170 may include a protruding lip, ridge, or rim that may extend either inwardly or outwardly from vertical sections 165. Each of vertical sections 165 may be attached at alternating large ends and small ends using flanges 170. In other embodiments, vertical sections may be attached using screws, bolts, or any other form of attachment. As further depicted in FIG. 1B and FIG. 1C, vertical sections 165 may further include alignment castellations 172. Alignment castellations 172 may comprise an alternating groove or protrusion from an edge of vertical section 165. Alignment castellations 172 may facilitate alignment of adjacent vertical sections 165 during assembly.

As further depicted in FIG. 1C, baffles, such as downward baffle 140A, may include stepped surfaces 185. Stepped surfaces 185 may comprise surfaces that may extend horizontally or at an angle from vertical section 165. Stepped surfaces 185 may be separated by grooves 190. Grooves 190 may comprise a vertical step between an upper stepped surface 185 and a lower stepped surface 185. Grooves 190 may further comprise a location where two twin sheets may meet and fuse together during molding to form a twin sheet molded downward baffle 140A. Grooves 190 may extend vertically or at an angle between an upper stepped surface 185 and a lower stepped surface 185, such that stepped surfaces 185 extend downwardly as stepped surfaces 185 extend away from vertical section 165. While FIG. 1C depicts three grooves 190, downward baffle 140A may include any number of grooves. Downward baffle 140A may further include outer lip 197 and inner lip 198. Outer lip 197 may extend circumferentially around the outer edge of downward baffle 140A. Inner lip 198 may extend circumferentially around the inner edge of the outermost stepped surface 185 of downward baffle 140A. Outer lip 197 and inner lip 198 may extend vertically from the surface of downward baffle 140A. Outer lip 197 and inner lip 198 may provide support to the outer stepped surface 185. Although stepped surfaces 185 and grooves 190 are described with reference to downward baffle 140A, any of upward baffles 135A-135C and/or downward baffles 140A-140C, as depicted in FIG. 1A, may include stepped surfaces and grooves.

In some embodiments, as depicted in FIG. 1D, vertical cylinder 115 may be formed from connected vertical sections 165 and vertical riser 175. Vertical riser 175 may include a larger end and a smaller end. In some embodiments, the larger end and the smaller end of vertical riser 175 may be circular in shape. In other embodiments, each of the larger end and the smaller end of vertical riser 175 may be rectangular, square, elliptical, polygonal, or any other shape. The walls of vertical riser 175 may taper from the larger end inwardly towards the smaller end. Vertical riser 175 may attach to a vertical section 165. For example, vertical riser 175 may attach to vertical section 165 that is molded with upper cone 125. Vertical sections 165 that are molded with upward baffles, such as upward baffle 135A, and downward baffles, such as downward baffle 140A, may also be attached to vertical section 165 that is molded with upper cone 125. As depicted in FIG. 1D, vertical riser 175 may further include alignment castellations 172. Alignment castellations 172 may comprise an alternating groove or protrusion from an edge of vertical riser 175. Alignment castellations 172 may facilitate alignment of vertical riser 175 with an adjacent vertical section 165 during assembly. Vertical riser 175 may include inlet port 120. Inlet port 120 may comprise an opening in vertical riser 175 that may allow the flow of stormwater to enter and flow downwardly through the connected vertical sections 165. Vertical riser 175 may further include ribs 180. Ribs 180 may protrude outwardly from a surface of vertical riser 175 and may provide structural support for vertical riser 175.

As depicted in FIG. 1E and FIG. 1F, upward baffle 135A may include ribs 167 and opening 168. Opening 168 may facilitate a flow of stormwater upwardly through upward baffle 135A, as disclosed herein. Ribs 167 may provide structural support to baffle 135A and may connect the outer portion of upward baffle 135A with vertical cylinder 165. The size and shape of opening 168 may vary based on the desired flow rate of stormwater through upward baffle 135A. Although FIGS. 1E and 1F depict ribs 167 and opening 168 on upward baffle 135A, each of upward baffles 135A-135C, as depicted in FIG. 1A, may include ribs and openings.

Returning to FIG. 1A, separator 100 may further include sump chamber 130, which may contain a flow of stormwater from inlet chamber 110 and may allow for sediment and other particulates to settle from the stormwater at base 145 of separator 100. Sump chamber 130 may include a plurality of upward baffles 135A-135C and downward baffles 140A-140C. Each of upward baffles 135A-135C and downward baffles 140A-140C may include first ends and second ends. In some embodiments, the first ends and second ends may be circular in shape. The first ends may comprise a larger diameter than the second ends. Upward baffles 135A-135C may be oriented such that the larger first ends are above the smaller second ends. The larger first ends of upward baffles 135A-135C may extend towards tubular body 160 of separator 100. In some embodiments, the larger first ends of upward baffles 135A-135C may contact the inner wall of tubular body 160. In other embodiments, there may be a gap between the larger first ends of upward baffles 135A-135C and the inner wall of tubular body 160. In some embodiments, the gap between the larger first ends of upward baffles 135A-135C and the inner wall of tubular body 160 may be between about 0.5 inches and two inches. In other embodiments, the gap may be less than 0.5 inches or greater than two inches. Downward baffles 140A-140C may be oriented such that the larger first ends are below the smaller second ends. The second ends of downward baffles 140A-140C may be attached to vertical cylinder 115. In some embodiments, one or more of upward baffles 135A-135C and/or one or more of downward baffles 140A-140C may be attached to the inner wall of tubular body 160. For example, one or more of upward baffles 135A-135C and/or one or more of downward baffles 140A-140C may be mounted to the inner wall of tubular body 160 using a mounting bracket or any other form of attachment. An angle, extending from a vertical axis of vertical cylinder 115, of upward baffles 135A-135C and downward baffles 140A-140C may be between 0 degrees to about 65 degrees. For example, in some embodiments, upward baffles 135A-135C could be situated horizontally if the angle were 0 degrees. Similarly, in some embodiments, downward baffles 140A-140C may be situated horizontally if the angle were 0 degrees. In other embodiments, an angle of upward baffles 135A-135C and downward baffles 140A-140C may be about 20 degrees.

Upward baffles 135A-135C and downward baffles 140A-140C may be stacked along vertical cylinder 115 in an alternating pattern. A distance between adjacent upward baffles 135A-135C and downward baffles 140A-140C along vertical cylinder 115 may vary depending on flow rates of the stormwater and the height of tubular body 160. For example, in some embodiments, spacing between adjacent upward baffles 135A-135C and downward baffles 140A-140C may range from about 2 inches to about 13 inches. In other embodiments, spacing between adjacent upward baffles 135A-135C and downward baffles 140A-140C may be 5.5 inches. In other embodiments, the spacing between adjacent upward baffles 135A-135C and downward baffles 140A-140C may be less than 2 inches or greater than 13 inches. Although FIG. 1A depicts three upward baffles 135A-135C and three downward baffles 140A-140C, any number of upward baffles and downward baffles may be included in separator 100.

The flow of stormwater may exit vertical cylinder 115 within sump chamber 130 and flow through the alternating upward baffles 135A-135C and downward baffles 140A-140C. Upward baffles 135A-135C and downward baffles 140A-140C may reduce the velocity of the flow of stormwater, which may increase the amount of particulates and sediment that may settle from the stormwater within sump chamber 130. The use of upward baffles 135A-135C and downward baffles 140A-140C may also provide more surface area within sump chamber 130 to facilitate settling of particulates and sediment from the stormwater. Upward baffles 135A-135C and downward baffles 140A-140C may also mitigate the risk of resuspended sediment short-circuiting to outlet 155 under high flow conditions. The sediment and particulates may settle out of the stormwater within sump chamber 130 and accumulate at base 145 of tubular body 160. The flow of treated stormwater may then exit sump chamber 130 through outlet 155 by flowing vertically through tubular body 160.

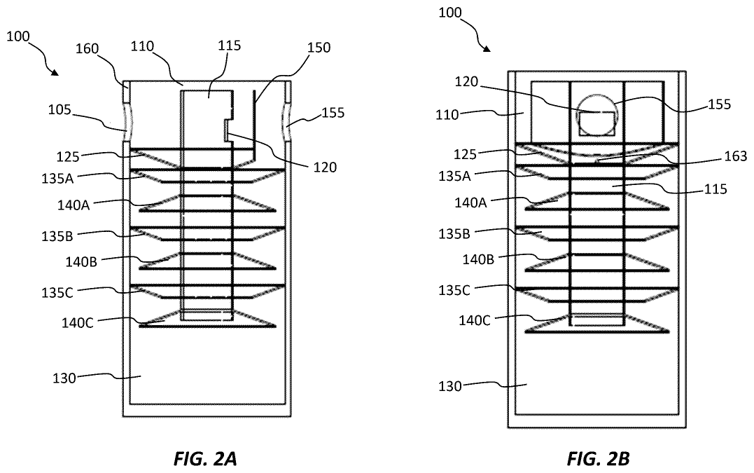

FIG. 2A depicts a side view of separator 100. As depicted in FIG. 2A, upper cone 125 may be attached to vertical cylinder 115 at the smaller end of upper cone 125. Upper cone 125 may extend between the inner walls of tubular body 160 to separate inlet chamber 110 from sump chamber 130. As further depicted in FIG. 2A, the smaller ends of downward baffles 140A-140C may be attached to vertical cylinder 115. In some embodiments, downward baffles 140A-140C may not extend to the inner wall of tubular body 160, and there may be a gap between the larger end of downward baffles 140A-140C and the inner wall of tubular body 160. For example, in some embodiments, a gap between the larger end of downward baffles 140A-140C and the inner wall of tubular body 160 may be about three inches. In other embodiments, the gap between the larger end of downward baffles 140A-140C and the inner wall of tubular body 160 may be greater than or less than three inches. In other embodiments, the larger end of downward baffles 140A-140C may be attached to the inner wall of tubular body 160. In such an embodiment, there may be a gap between vertical cylinder 115 and the smaller ends of downward baffles 140A-140C.

As also depicted in FIG. 2A, in some embodiments, the larger ends of upward baffles 135A-135C may extend towards the inner wall of tubular body 160. As depicted in FIG. 2A, the larger ends of upward baffles 135A-135C may contact the inner wall of tubular body 160. In other embodiments, there may be a gap between the larger ends of upward baffles 135A-135C and the inner wall of tubular body 160. In some embodiments, the gap between the larger ends of upward baffles 135A-135C and the inner wall of tubular body 160 may be between about 0.5 inches and two inches. In other embodiments, the gap may be less than 0.5 inches or greater than two inches. There may be a gap between vertical cylinder 115 and the smaller ends of upward baffles 135A-135C. In some embodiments, the gap between vertical cylinder 115 and the smaller ends of upward baffles 135A-135C may be about six inches. In other embodiments, the gap between vertical cylinder 115 and the smaller ends of upward baffles 135A-135C may be greater than or less than about six inches. In other embodiments, the smaller ends of upward baffles 135A-135C may be attached to vertical cylinder 115. In such embodiments, upward baffles 135A-135C may not extend to the inner wall of tubular body 160, and there may be a gap between the larger end of upward baffles 135A-135C and the inner wall of tubular body 160.

As depicted in FIG. 2A, an upward baffle, such as upward baffle 135A may be located directly beneath upper cone 125. Upward baffles 135A-135C and downward baffles 140A-140C may then alternate downwardly along the length of vertical cylinder 115. However, in other embodiments, one of downward baffles 140A-140C may be located directly beneath upper cone 125. In such embodiments, downward baffles 140A-140C and upward baffles 135A-135C may alternate downwardly along the length of vertical cylinder 115. Particulates and sediment may settle from the flow of stormwater as the stormwater flows upwardly through upward baffles 135A-135C and downward baffles 140A-140C. The pattern of alternating upward baffles 135A-135C and downward baffles 140A-140C may allow particulates that settle from the flow of stormwater onto upward baffles 135A-135C and/or downward baffles 140A-140C to slide downwardly along the baffles towards base 145 of sump region 130. Accordingly, the pattern of alternating upward baffles 135A-135C and downward baffles 140A-140C may create a downward path towards base 145 of sump region 130 for settled particulates and sediment.

FIG. 2B depicts a rear view of separator 100. As depicted in FIG. 2B, vertical cylinder 115 may include inlet port 120, which may include a rectangular opening in vertical cylinder 115 that may allow stormwater to flow from inlet chamber 110 to sump chamber 130. In other embodiments, inlet port 120 may be square, circular, ovular, or any other shape. Vertical cylinder 115 further includes drain port 163. Drain port 163 may comprise an opening in vertical cylinder 115 that may allow settled sediment to be washed to sump chamber 130. Although FIG. 2B depicts one drain port 163, vertical cylinder 115 may include more than one drain port 163. The flow of stormwater may exit sump chamber 130 through outlet 155 after flowing in a vertical direction through upward baffles 135A-135C and downward baffles 140A-140C.

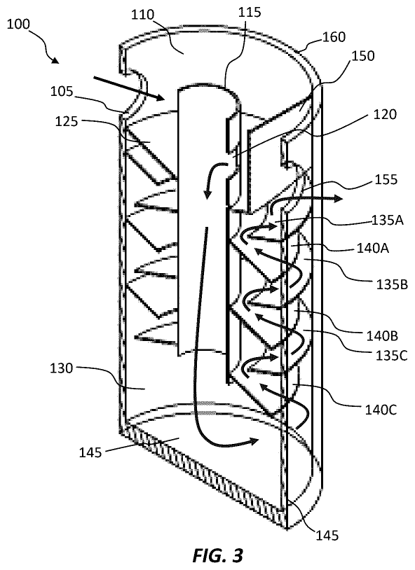

FIG. 3 depicts a flow of stormwater through separator 100. As depicted in FIG. 3, stormwater may flow into inlet chamber 110 of separator 100 through inlet 105. The flow of stormwater may be maintained within inlet chamber 110 by upper cone 125, which may separate inlet chamber 110 from sump chamber 130. The flow of stormwater may flow from inlet chamber 110 to vertical cylinder 115 through inlet port 120 of vertical cylinder 115. The flow of stormwater may flow downward through vertical cylinder 115 from inlet chamber 110 to sump chamber 130. Sediment and particulates may settle out of the flow of stormwater in sump chamber 130. The flow of stormwater may then flow upwardly through the alternating upward baffles 135A-135B and downward baffles 140A-140C of sump chamber 130. For example, the flow of stormwater may flow through the gaps between the larger end of downward baffles 140A-140C and the inner wall of tubular body 160 and through the gaps between the smaller end of upward baffles 135A-135C and vertical cylinder 115. Upward baffles 135A-135C and downward baffles 140A-140C may reduce the velocity of the flow of stormwater, which may increase the amount of particulates and sediment that may settle from the stormwater within sump chamber 130. The use of upward baffles 135A-135C and downward baffles 140A-140C may also provide more surface area within sump chamber 130 to facilitate settling of particulates and sediment from the stormwater. Upward baffles 135A-135C and downward baffles 140A-140C may also mitigate the risk of resuspended sediment short-circuiting to outlet 155 under high flow conditions. For example, upward baffles 135A-135C and downward baffles 140A-140C may prevent sediment and particulates from flowing upwardly within sump region 130 to outlet 155. The sediment and particulates may settle out of the stormwater within sump chamber 130 and accumulate at base 145 of tubular body 160. The flow of treated stormwater may then exit sump chamber 130 through outlet 155.

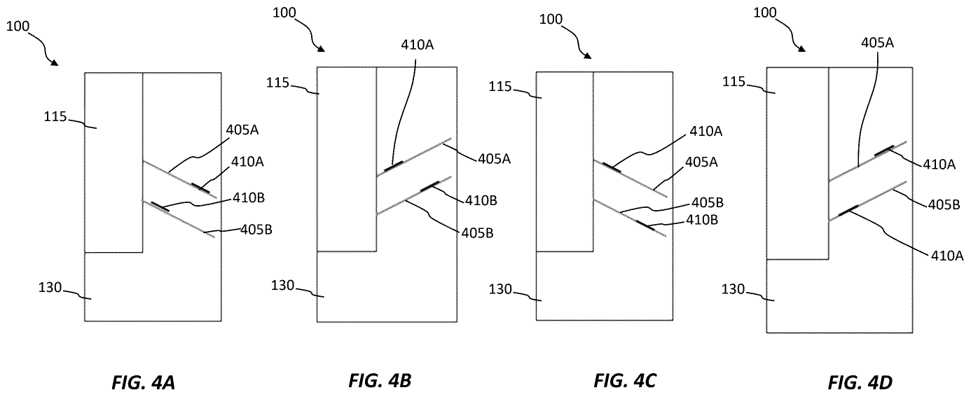

FIGS. 4A-4D depict an enlarged section cut of separator 100 with baffles 405A-405B. As depicted in FIGS. 4A-4D, baffles 405A-405B may be attached to vertical cylinder 115 in sump chamber 130 of separator 100. Baffles 405A-405B may each comprise a cone extending fully around vertical cylinder 115. Baffles 405A-405B may be configured to control a flow of stormwater within sump chamber 130 to allow sediments and particulates to settle from the flow of stormwater before exiting sump chamber 130. As depicted in each of FIGS. 4A-4D, baffles 405A-405B may extend in parallel at an upward angle or a downward angle towards an inner wall of separator 100. While baffles 405A-405B do not extend all the way to the inner wall of separator 100 in the embodiments depicted in FIGS. 4A-4D, in other embodiments (not shown), one or more of baffles 405A-405B may extend all the way to and may contact the inner wall of separator 100. As depicted in each of FIGS. 4A-4D, each of baffles 405A-405B may include a window 410A-410B. Window 410A-410B may comprise an opening in baffles 405A-405B, which may allow a flow of treated stormwater to flow through baffles 405A-405B upwardly towards an outlet (not depicted) of separator 100. As depicted in FIGS. 4B and 4C, window 410A may be located closer to vertical cylinder 115 along baffle 405A and window 410B may be located closer to an inner wall of separator 100 along baffle 405B. In some embodiments, window 410A may extend all the way to vertical cylinder 115 and/or window 410B may extend all the way to the inner wall of separator 100. As depicted in FIGS. 4A and 4D, window 410A may be located closer to an inner wall of separator 100 along baffle 405A and window 410B may be located closer to vertical cylinder 115 along baffle 410B. In some embodiments, window 410A may extend all the way to the inner wall of separator 100 and/or window 410B may extend all the way to vertical cylinder 115. Although FIGS. 4A-4D depict two baffles 405A-405B, separator 100 may include any number of baffles within sump chamber 130. Further, each of baffles 405A-405B may include more than one window along the length of baffle 405A-405B. In some embodiments, the size and shape of windows 410A and 410B may be the same and in other embodiments, the size and shape of windows 410A and 410B may vary. For example, in some embodiments, the size of window 410A may be smaller than the size of window 410B. In such an embodiment, the decreasing size of window 410A compared to window 410B may further facilitate the settlement of particulates and sediment out of the flow of stormwater.

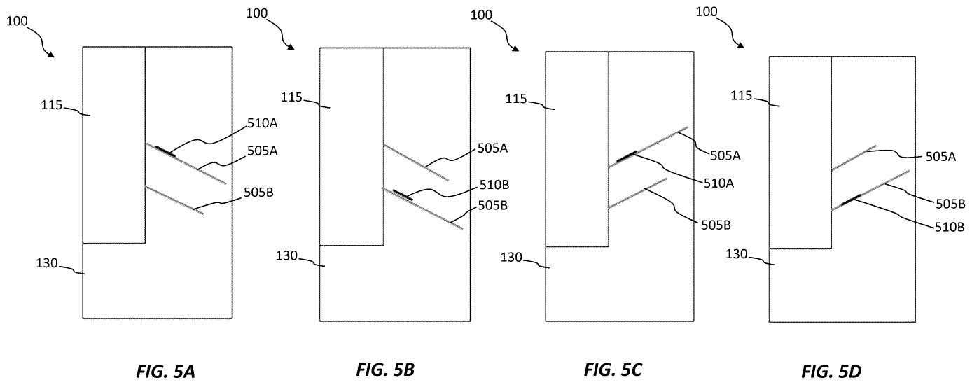

FIGS. 5A-5D depict an enlarged section cut of separator 100 with parallel baffles of varying widths. As depicted in FIGS. 5A-5D, baffles 505A-505B may be attached to vertical cylinder 115 in sump chamber 130 of separator 100. Baffles 505A-505B may each comprise a cone extending fully around vertical cylinder 115. Baffles 505A-505B may be configured to control a flow of stormwater within sump chamber 130 to allow sediments and particulates to settle from the flow of stormwater before exiting sump chamber 130. As depicted in each of FIGS. 5A-5D, baffles 505A-505B may extend in parallel at an upward angle or a downward angle towards an inner wall of separator 100. As depicted in FIGS. 5A and 5C, the width of baffle 505B may be less than the width of baffle 505A. In such embodiments, a flow of stormwater may pass through the gap between baffle 505B and the inner wall of separator 100. Further, in such embodiments, baffle 505A may include a window 510A. Window 510A may comprise an opening in baffle 505A, which may allow a flow of treated stormwater to pass through baffle 505A upwardly towards an outlet (not depicted) of separator 100. In some embodiments, window 510A may extend all the way to the inner wall of separator 100 or all the way to vertical cylinder 115. While baffles 505A-505B do not extend all the way to the inner wall of separator 100 in the embodiments depicted in FIGS. 5A-5D, in other embodiments (not shown), baffles 505A-505B, if comprising one or more windows 510A, 510B, respectively, may extend all the way to and may contact the inner wall of separator 100. As depicted in FIGS. 5B and 5D, the width of baffle 505A may be less than the width of baffle 505B. In such embodiments, a flow of stormwater may pass through the gap between baffle 505A and an inner wall of separator 100. Further, in such embodiments, baffle 505B may comprise window 510B. Window 510B may comprise an opening in baffle 505B, which may allow a flow of treated stormwater to pass through baffle 505B upwardly towards an outlet (not depicted) of separator 100. In some embodiments, window 510B may extend all the way to the inner wall of separator 100 or all the way to vertical cylinder 115. Although FIGS. 5A-5D depict two baffles 505A-505B, separator 100 may include any number of baffles of varying widths within sump chamber 130. In some embodiments, the size and shape of windows 510A and 510B may be the same and in other embodiments, the size and shape of windows 510A and 510B may vary.

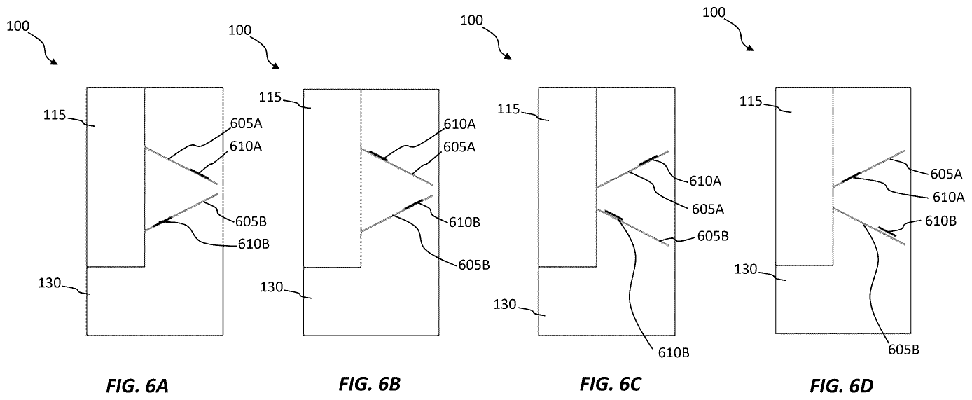

FIGS. 6A-6D depict an enlarged section cut of separator 100 with non-parallel baffles. As depicted in FIGS. 6A-6D, baffles 605A-605B may be attached to vertical cylinder 115 in sump chamber 130 of separator 100. Baffles 605A-605B may each comprise a cone extending fully around vertical cylinder 115. Baffles 605A-605B may be configured to control a flow of stormwater within sump chamber 130 to allow sediments and particulates to settle from the flow of stormwater before exiting sump chamber 130. As depicted in each of FIGS. 6A-6D, baffles 605A-605B may extend in non-parallel directions at an upward angle or a downward angle towards an inner wall of separator 100. For example, baffle 605A may extend at an upward angle while baffle 605B may extend at a downward angle, or vice versa. Each of baffles 605A-605B may include a window 610A-610B. Window 610A-610B may comprise an opening in baffles 605A-605B, which may allow a flow of treated stormwater to flow through baffles 605A-605B upwardly towards an outlet (not depicted) of separator 100. While baffles 605A-605B do not extend all the way to the inner wall of separator 100 in the embodiments depicted in FIGS. 6A-6D, in other embodiments (not shown), one or more of baffles 605A-605B may extend all the way to and may contact the inner wall of separator 100. As depicted in FIGS. 6B and 6D, window 610A may be located closer to vertical cylinder 115 along baffle 605A and window 610B may be located closer to an inner wall of separator 100 along baffle 605B. In some embodiments, window 610A may extend all the way to the vertical cylinder 115 and/or window 610B may extend all the way to the inner wall of separator 100. As depicted in FIGS. 6A and 6C, window 610A may be located closer to an inner wall of separator 100 along baffle 605A and window 610B may be located closer to vertical cylinder 115 along baffle 610B. In some embodiments, window 610A may extend all the way to the inner wall of separator 100 and/or window 610B may extend all the way to vertical cylinder 115. Although FIGS. 6A-6D depict two baffles 605A-605B, separator 100 may include any number of baffles within sump chamber 130. Additionally, each of baffles 605A-605B may include more than one window along the length of baffle 605A-605B. In some embodiments, the size and shape of windows 610A and 610B may be the same and in other embodiments, the size and shape of windows 610A and 610B may vary.

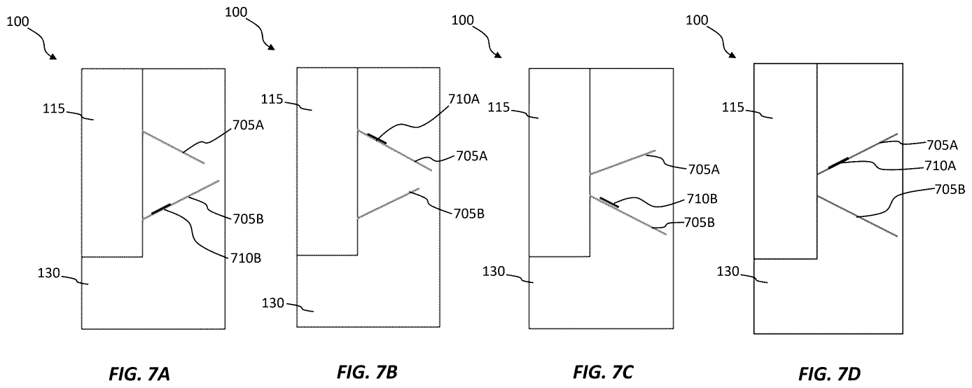

FIGS. 7A-7D depict an enlarged section cut of separator 100 with a plurality of non-parallel baffles of varying widths. As depicted in FIGS. 7A-7D, baffles 705A-705B may be attached to vertical cylinder 115 in sump chamber 130 of separator 100. Baffles 705A-705B may each comprise a cone extending fully around vertical cylinder 115. Baffles 705A-705B may be configured to control a flow of stormwater within sump chamber 130 to allow sediments and particulates to settle from the flow of stormwater before exiting sump chamber 130. As depicted in each of FIGS. 7A-7D, baffles 705A-705B may extend in non-parallel directions at an upward angle or a downward angle towards an inner wall of separator 100. As depicted in FIG. 7B, the width of baffle 705B may be less than the width of baffle 705A. In such embodiments, a flow of stormwater may pass through the gap between baffle 705B and the inner wall of separator 100. Further, in such embodiments, baffle 705A may include a window 710A. Window 710A may comprise an opening in baffle 705A, which may allow a flow of treated stormwater to pass through baffle 705A upwardly towards an outlet (not depicted) of separator 100. In some embodiments, window 710A may extend all the way to the inner wall of separator 100 or all the way to vertical cylinder 115. While baffles 705A-705B do not extend all the way to the inner wall of separator 100 in the embodiments depicted in FIGS. 7A-7D, in other embodiments (not shown), baffles 705A-705B, if comprising one or more windows 710A, 710B, respectively, may extend all the way to and may contact the inner wall of separator 100. As depicted in FIGS. 7A and 7C, the width of baffle 705A may be less than the width of baffle 705B. In such embodiments, a flow of stormwater may pass through the gap between baffle 705A and an inner wall of separator 100. Further, in such embodiments, baffle 705B may comprise window 710B. Window 710B may comprise an opening in baffle 705B, which may allow a flow of treated stormwater to pass through baffle 705B upwardly towards an outlet (not depicted) of separator 100. In some embodiments, window 710B may extend all the way to the inner wall of separator 100 or all the way to vertical cylinder 115. Although FIGS. 7A-7D depict two baffles 705A-705B, separator 100 may include any number of baffles of varying widths within sump chamber 130. In some embodiments, the size and shape of windows 710A and 710B may be the same and in other embodiments, the size and shape of windows 710A and 710B may vary.

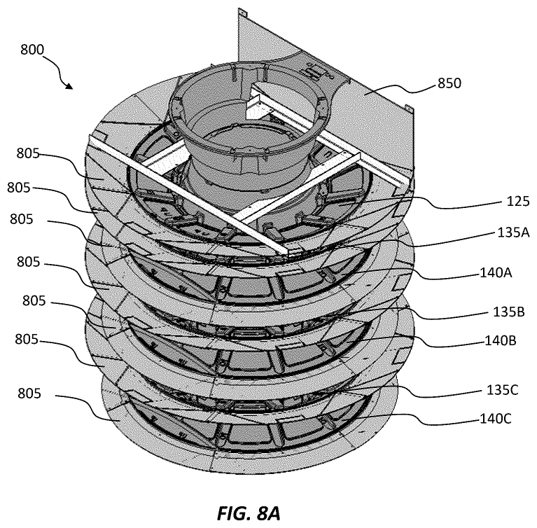

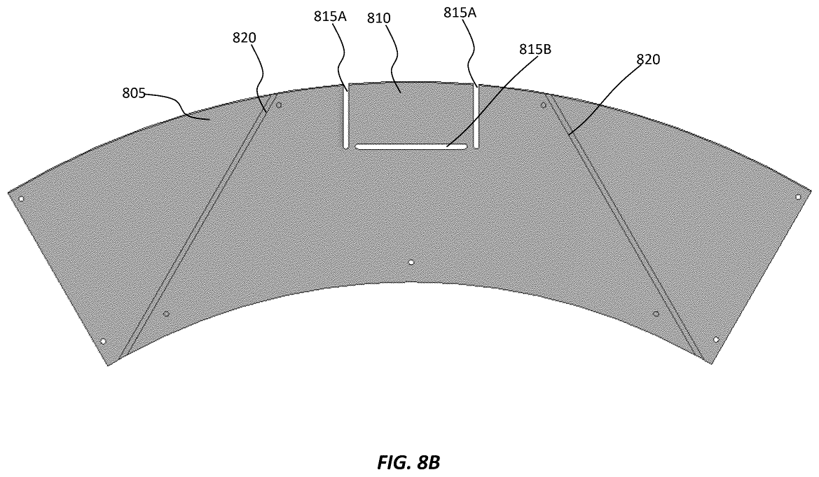

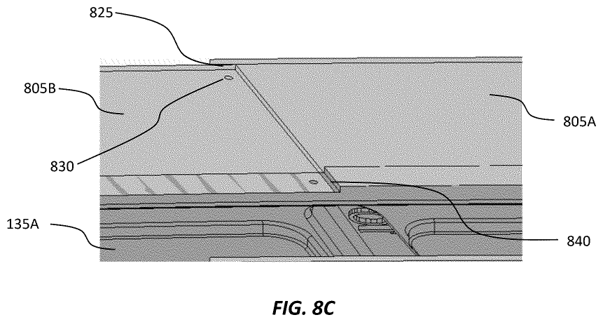

FIG. 8A depicts separator 800 with a plurality of plate extensions 805 around each upward baffle 135A-135C and downward baffle 140A-140C, according to disclosed embodiments. Plate extensions 805 may allow separator 800 to be installed within a larger tubular body, such as tubular body 160 (not depicted in FIG. 8A), by extending the diameter of upward baffles 135A-135C and downward baffles 140A-140C. For example, in some embodiments, a diameter of the tubular body 160 in which separator 800 will be installed may be 10 feet. In such embodiments, the diameter of upward baffles 135A-135C may be about 93 inches and downward baffles 140A-140C may be about 84 inches. Plate extensions 805 may be attached to the outer edges of upward baffles 135A-135C and downward baffles 140A-140C such that the diameter of upward baffles 135A-135C with extension plate 805 may be about 116-120 inches and the diameter of downward baffle 140A-140C with extension plate 805 may be about 105-109 inches.

As depicted in FIG. 8B, plate extensions 805 may comprise a flat stock plate. During assembly, plate extensions 805 may be flexed and interconnected to form a three-dimensional cone segment that may be attached to the outer edges of upward baffles 135A-135C and downward baffles 140A-140C. In some embodiments, as depicted in FIG. 8A, six interconnected plate extensions 805 may be connected and assembled around each upward baffle 135A-135C and each downward baffle 140A-140C. In other embodiments, more or fewer plate extensions 805 may be connected to fully extend around the outer circumference of each upward baffle 135A-135C and each downward baffle 140A-140C.

FIG. 8C depicts an enlarged view of a connection between upward baffle 135A and first plate extension 805A and second plate extension 805B. When assembling plate extensions around one of upward baffles 135A-135C or downward baffles 140A-140C, a first plate extension 805A may overlap a second plate extension 805B, as depicted in FIG. 8C. An outer edge of upward baffles 135A-135C or downward baffles 140A-140C may include indentation 840. Indentation 840 may facilitate assembly of first plate extension 805A and second plate extension 805B. For example, lap joint 825 formed by the overlapping of first plate extension 805A and second plate extension 805B may align with indentation 840. This may aid an installer in aligning the interconnected plate extensions 805 with each of upward baffles 135A-135C or downward baffles 140A-140C. First plate extension 805A and second plate extension 805B may be connected to each other and to the edge of each of upward baffles 135A-135C or downward baffles 140A-140C by a fastener, such as a nut and bolt, installed through holes 830.

Returning to FIG. 8B, plate extensions 805 may comprise flap 810 formed by cutouts 815A and 815B. In some embodiments, when installing separator 800 within tubular body 160, brackets may be installed within tubular body 160 to support separator 800. Such brackets may be installed in tubular body 160 before separator 800 is placed within tubular body 160 and may extend inwardly towards the center of tubular body 160. Flap 810 may deflect around the brackets within tubular body 160 when separator 800 is lowered into tubular body 160 during installation. After plate extension 805 passes the bracket, flap 810 may return to its original position. When flap 810 returns to its original position, as depicted in FIG. 8B, it may substantially diminish or minimize water from short circuiting around plate extension 805.

Plate extension 805 may also include notches 820. Notches 820 may provide a guide for an installer and may indicate a location to cut plate extension 805. For example, when plate extension 805 is assembled around upper cone 125, as depicted in FIG. 8A, plate extension 805 may need to be cut to allow for assembly of weir 850. Weir 850 may correspond to weir 150, as disclosed herein with respect to FIG. 1A.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations and/or alterations based on the present disclosure. Other embodiments will be apparent from consideration of the specification and practice of the embodiments disclosed herein.

Embodiments of the present disclosure may further be described with respect to the following clauses:
Clause 1. A separator configured to remove particulate matter and pollutants from a flow of stormwater, the separator comprising:
   a tubular body, the tubular body comprising an inlet chamber and a sump chamber separated by an upper cone;
   a vertical cylinder extending from the inlet chamber to the sump chamber;
   a plurality of upward baffles in the sump chamber, wherein the plurality of upward baffles extend towards an inner wall of the tubular body;
   a plurality of downward baffles in the sump chamber, wherein the plurality of downward baffles are attached to the vertical cylinder; and
   wherein the plurality of upward baffles and the plurality of downward baffles alternate along a length of the vertical cylinder.
Clause 2. The separator of clause 1, wherein the tubular body further comprises an inlet and an outlet.
Clause 3. The separator of clause 2, wherein the inlet chamber is configured to contain the flow of stormwater entering the tubular body from the inlet.
Clause 4. The separator of clause 1, wherein a diameter of the upper cone corresponds to a diameter of the tubular body.
Clause 5. The separator of clause 2, wherein the upper cone further comprises a bypass weir configured to prevent the flow of stormwater in the inlet chamber from exiting the inlet chamber through the outlet in low flow conditions.
Clause 6. The separator of clause 1, wherein the vertical cylinder comprises a plurality of connected vertical sections, wherein each of the plurality of vertical sections taper from a larger first end towards a smaller second end.
Clause 7. The separator of clause 1, wherein the vertical cylinder comprises an inlet port configured to allow the flow of stormwater to enter the sump chamber from the inlet chamber.
Clause 8. The separator of clause 1, wherein the sump chamber is configured to permit sediments to settle from the flow of stormwater at a base of the sump chamber.
Clause 9. The separator of clause 1, wherein each of the plurality of upward baffles comprises:
   a first end having a first diameter; and
   a second end having a second diameter;
   wherein the first diameter is larger than the second diameter.
Clause 10. The separator of clause 9, wherein the second end of each of the plurality of upward baffles is located below the first end.
Clause 11. The separator of clause 9, further comprising a gap between the second end of each of the plurality of upward baffles and the vertical cylinder.
Clause 12. The separator of clause 1, wherein each of the plurality of downward baffles comprises:
   a first end having a first diameter; and
   a second end having a second diameter;
   wherein the first diameter is larger than the second diameter.
Clause 13. The separator of clause 12, wherein the second end of the plurality of downward baffles is located above the first end.
Clause 14. The separator of clause 12, further comprising a gap between the first end of each of the plurality of downward baffles and an inner wall of the tubular body.
Clause 15. The separator of clause 1, wherein the plurality of upward baffles and the plurality of downward baffles extend at an angle between 0 degrees to about 65 degrees.
Clause 16. The separator of clause 1, wherein a space between an adjacent one of the plurality of upward baffles and one of the plurality of downward baffles comprises a distance between about 2 inches to about 13 inches.
Clause 17. The separator of clause 1, wherein the plurality of upward baffles comprises three upward baffles.
Clause 18. The separator of clause 1, wherein the plurality of downward baffles comprises three downward baffles.
Clause 19. The separator of clause 1, wherein the flow of stormwater is configured to flow between the plurality of upward baffles and the plurality of downward baffles to an outlet.
Clause 20. The separator of clause 1, wherein the vertical cylinder further comprises at least one drain port.
Clause 21. The separator of clause 1, further comprising a plurality of plate extensions connected to an outer edge of each of the plurality of upward baffles and each of the plurality of downward baffles.
Clause 22. The separator of clause 21, wherein each of the plurality of plate extensions comprises a flat stock plate.
Clause 23. The separator of clause 21, wherein the plurality of plate extensions comprises six plate extensions.
Clause 24. The separator of clause 21, wherein each of the plurality of upward baffles and each of the plurality of downward baffles comprises a plurality of indentations configured to align with a lap joint formed by a first plate extension overlapping a second plate extension.
Clause 25. The separator of clause 22, wherein each of the plurality of plate extensions comprises a flap.
Clause 26. The separator of clause 25, wherein the flap is formed by cutouts through a surface of the flat stock plate.
Clause 27. The separator of clause 26, wherein the flap is configured to deflect around a bracket installed on an inner wall of the tubular body.
Clause 28. The separator of clause 21, wherein each of the plurality of plate extensions comprises one or more notches configured to mark a location for cutting each of the plurality of plate extensions.

What is claimed is:

1. A separator configured to remove particulate matter and pollutants from a flow of stormwater, the separator comprising:
a tubular body, the tubular body comprising an inlet chamber and a sump chamber separated by an upper cone;
a vertical cylinder extending from the inlet chamber to the sump chamber;
a plurality of upward baffles in the sump chamber, wherein the plurality of upward baffles extend towards an inner wall of the tubular body;
a plurality of downward baffles in the sump chamber, wherein the plurality of downward baffles are attached to the vertical cylinder; and
wherein the plurality of upward baffles and the plurality of downward baffles alternate along a length of the vertical cylinder.

2. The separator of claim 1, wherein the tubular body further comprises an inlet and an outlet.

3. The separator of claim 2, wherein the inlet chamber is configured to contain the flow of stormwater entering the tubular body from the inlet.

4. The separator of claim 1, wherein a diameter of the upper cone corresponds to a diameter of the tubular body.

5. The separator of claim 2, wherein the upper cone further comprises a bypass weir configured to prevent the flow of stormwater in the inlet chamber from exiting the inlet chamber through the outlet.

6. The separator of claim 1, wherein the vertical cylinder comprises a plurality of connected vertical sections, wherein each of the plurality of vertical sections taper from a larger first end towards a smaller second end.

7. The separator of claim 1, wherein the vertical cylinder comprises an inlet port configured to allow the flow of stormwater to enter the sump chamber from the inlet chamber.

8. The separator of claim 1, wherein the sump chamber is configured to permit sediments to settle from the flow of stormwater at a base of the sump chamber.

9. The separator of claim 1, wherein each of the plurality of upward baffles comprises:
a first end having a first diameter; and
a second end having a second diameter;
wherein the first diameter is larger than the second diameter.

10. The separator of claim 9, wherein the second end of each of the plurality of upward baffles is located below the first end.

11. The separator of claim 9, further comprising a gap between the second end of each of the plurality of upward baffles and the vertical cylinder.

12. The separator of claim 1, wherein each of the plurality of downward baffles comprises:
a first end having a first diameter; and
a second end having a second diameter;
wherein the first diameter is larger than the second diameter.

13. The separator of claim 12, wherein the second end of the plurality of downward baffles is located above the first end.

14. The separator of claim 12, further comprising a gap between the first end of each of the plurality of downward baffles and an inner wall of the tubular body.

15. The separator of claim 1, wherein the plurality of upward baffles and the plurality of downward baffles extend at an angle between 0 degrees to about 65 degrees.

16. The separator of claim 1, wherein a space between an adjacent one of the plurality of upward baffles and one of the plurality of downward baffles comprises a distance between about 2 inches to about 13 inches.

17. The separator of claim 1, wherein the plurality of upward baffles comprises three upward baffles.

18. The separator of claim 1, wherein the plurality of downward baffles comprises three downward baffles.

19. The separator of claim 1, wherein the flow of stormwater is configured to flow between the plurality of upward baffles and the plurality of downward baffles to an outlet.

20. The separator of claim 1, wherein the vertical cylinder further comprises at least one drain port.
